(19) United States
(12) Patent Application Publication
(10) Pub. No.: US 2025/0207872 A1
(43) Pub. Date: Jun. 26, 2025

(54) Foam Hydronic Boards

(71) Applicants: Robert Morgan Muir, Oakland, CA (US); Alfred Hoyt Corbett, JR., Bainbridge Island, WA (US)

(72) Inventors: Robert Morgan Muir, Oakland, CA (US); Alfred Hoyt Corbett, JR., Bainbridge Island, WA (US)

(21) Appl. No.: 18/395,358

(22) Filed: Dec. 22, 2023

(51) Int. Cl. F28F 3/12; F28F 21/06

(52) U.S. Cl. CPC F28F 3/12; F28F 21/066

(57) ABSTRACT

Hydronic boards of polymer foam with heat conductive plates. Straight sections have plates with omega or U shaped grooves pre-adhered to the boards which have wider grooves to accommodate the outsides of grooves in the plates without contact on both sides at once. Transitions from straight sections are accomplished with a kit of grooved foam boards and plates to be adhered after tubing is inserted into the grooves. The boards and plates have break-line cracks allowing them to be easily broken into convenient sizes.

This application claims priority from U.S. provisional application No. 63/435,714 filed Dec. 28, 2022.

### BACKGROUND

Hydronic boards with heat conductive plates have been made with a grooved heat conductive plate of aluminum over a grooved board of plywood or fiberboard, where the grooves in the plate are sized to snugly receive hydronic polymer heat exchange tubing. A newer well known way of making the boards is to use polymer foam instead of plywood or fiberboard.

### SUMMARY OF THE INVENTION

The invention comprises improvements to hydronic boards with heat conductive plates, including boards made with polymer foam. In one aspect, the invention is a kit of plates and transition boards 10 with curved grooves for making turns comprising a rectangular board having a length and a width and grooves 7 sized to receive hydronic heat exchange tubing, and a flat, rectangular heat conductive plate with a length not substantially greater than the length of the board and a width not substantially greater than the width of the board, where an installer may adhere the plate to the board after tubing is inserted into the grooves 7 in the board 10. The length of the plate may be less than the length of the board, or the width of the plate may be less than the width of the board, or both. The grooves may be omega shaped or may have simply vertical sides with no convexity.

The transition board 10 may include one or more break-line cracks 6, each crack having a straight line shape and defining a plane extending through the board perpendicular to a surface of the board. Each crack extends through part of the defined plane but not all of the defined plane such that the board has enough strength to not break at the break-line crack from mere handling, but can be broken at the break-line crack by a person holding the board with two hands and pressing it at a table edge aligned with the break-line crack.

Likewise, the transition plate 9 may include one or more break-line cracks 11, each crack having a straight line shape and defining a plane extending through the plate 8 perpendicular to a surface of the plate. Each crack extends through part of the defined plane but not all of the defined plane such that the plate has enough strength to not break at the break-line crack from mere handling, but can be broken at the break-line crack by a person holding the plate with two hands and pressing it at a table edge aligned with the break-line crack.

When the plate is broken at a break-line crack into two or more pieces 9, the width of one of the pieces may be no greater than the width of the board. The board may consist principally of polymer foam. The grooves 7 may comprise 180 degree curved grooves so that the board can be used to make 180 degree turns in tubing. The grooves 7 in the transition board may have an undercut omega inside shape which allows the groove to retain a snug fitting tube.

In another aspect, the invention is a rectangular heat conductive plate 1 having a length and a width, the plate having been bent to have plate ridges 3 on a lower side and plate grooves 4 on an upper side, where the plate grooves are sized to snugly receive hydronic heat exchange tubing, and, adhered to the lower side of the plate, a rectangular board 2 having a length similar to the length of the plate and a width similar to the width of the plate, the board having board grooves 5 with two sides in which the plate ridges are disposed, the board grooves being wide enough between the two sides to receive the plate ridges 3 so that a perpendicular cross-section of a plate ridge is not touching both sides of a board groove at the same time so that the sides of a board groove do not impede initial flexing of a plate ridge as a tube is inserted. In the hydronic board with heat conductive plate, it may be that no perpendicular cross-section of a plate ridge 3 touches both sides of a perpendicular cross-section of a board groove 5 at the same time. In the hydronic board with heat conductive plate, each board groove 5 has a bottom and each board groove may be deep enough that no plate ridge 3 is touching the bottom of a board groove as shown in FIGS. 3 and 4. The plate grooves and ridges may be omega shaped or may have simply vertical sides such that the ridges are simply convex with no concavity and the plate grooves are simply concave with no convexity. The board 2 may consist principally of polymer foam.

In another aspect, the invention is a polymer foam board with heat conductive plate made by a process comprising the steps of having a rectangular heat conductive plate 1 with a length and a width, the plate bent to have ridges 3 on a lower side and plate grooves 4 on an upper side where the plate grooves are sized to snugly receive hydronic heat exchange tubing; having a rectangular board 2 of compatible length and width as the plate 1, the board consisting principally of polymer foam and having board grooves 5 large enough to receive the ridges of the plate; and, while the board is at room temperature, heating the plate to a temperature that will melt the polymer of the board, then pressing the plate to the board with the plate ridges inserted into the board grooves, and then allowing the plate and board to cool thereby adhering the plate to the board. The polymer foam may be EPS.

In another aspect, the invention is a hydronic board with heat conductive plate, comprising a board with one or more break-line cracks 6, each crack having a straight line shape and defining a plane extending through the board perpendicular to a surface of the board; each crack extending through part of the defined plane but not all of the defined plane such that the board has enough strength to not break at a break-line crack from mere handling but can be broken at the break-line crack by a person holding the board with two hands and pressing it at a table edge aligned with the break-line crack; and, adhered to the board, a plurality of heat conductive plates, each plate extending close to but not crossing a break-line crack.

### DESCRIPTION OF FIGURES

FIG. 1 Board and same size plate for straight sections

FIG. 2 Board with bonded plate for straight sections

FIG. 3 Cross section of straight board and plate where the board groove has a rounded bottom

FIG. 4 Cross section of straight board and plate where the board groove has a square bottom

FIG. 5 Transition board with break lines

FIG. 6 Shapes into which transition boards may be broken

FIG. 7 Scored metal transition plates and broken plate pieces

FIG. 8 Example of layout with straight boards, transition boards, and tubing

### DETAILED DESCRIPTION

Hydronic radiant floor, ceiling, and wall heating systems are most commonly done utilizing plastic tubing in cement, or by using tubing in a variety of board and metal plate options that go over cement or a wooden subfloor. In contrast, the disclosed Foam Hydronic Board System is a heat transfer kit that integrates a conductive emitter surface with channels (grooves) for tubing with insulation underlayment board, and uses high compressive strength insulation, formed aluminum (or other metals or other highly conductive material such as carbon or graphite fiber) plates with a variety of different shaped and modular parts that fit together to be systematically designed and installed. Most embodiments utilize a collection of modular panels (boards) comprised of Straight Panels (boards with adhered plates), and Transition Panels (kit of board plus plate).

The Transition Panels have serrated break-line cracks in the foam which allow the foam to be snapped or cut apart into sub-portions such as curved end piece portions and a transition by-pass portion, or portions of unchanneled filler panels. The Straight Panels may also have break-line cracks aligned with cracks in the adhered heat conductive layer.

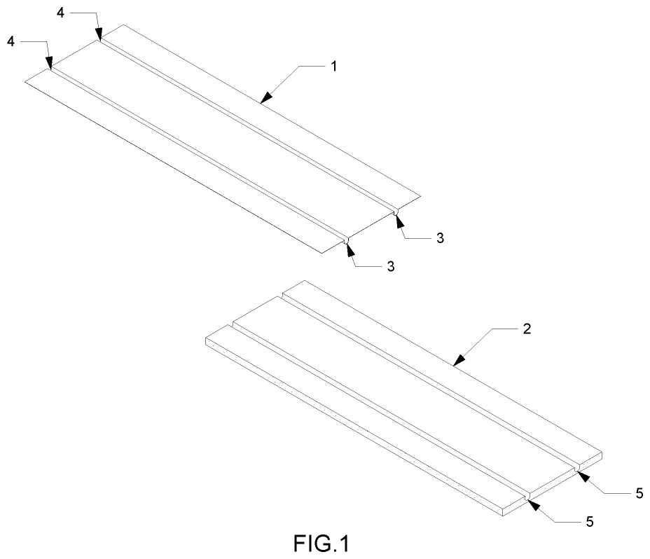

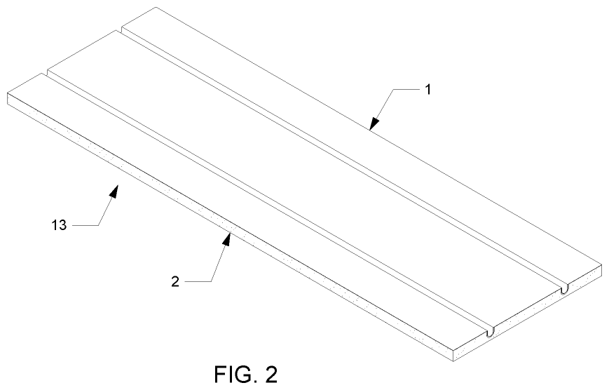

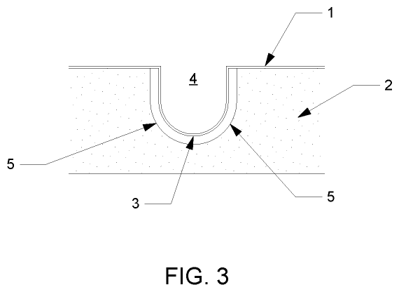

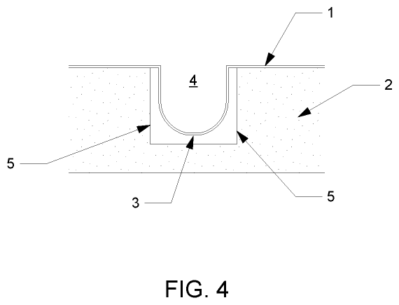

In a preferred embodiment, the Foam Board Hydronic Heating system includes 16″×48″ Straight pieces of foam board 2 with a crush resistance of greater than 60 PSI and has channels (grooves) 5 formed in it (FIG. 1). A metal or other heat emitting material plate 1 is bonded to the foam with glue or heat. In cross-section, the grooves may be rectangular as shown in FIG. 4 or U shaped as shown in FIG. 3. The plates are attached to the foam, with the grooved channels 5 of the foam sized wide enough to allow the outside surface (ridges) 3 of the grooves in the plate to flex to allow tubing 12 (through which heated fluid is pumped) to be pushed into and retained in the groove 4 of the plate (see FIG. 2).

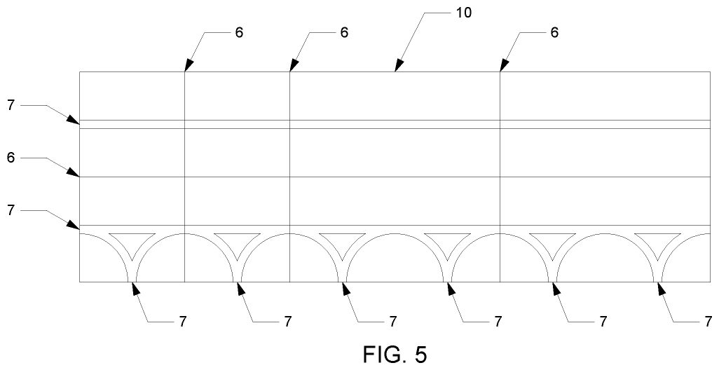

In a preferred embodiment, the Transition panels 10 and the Straight Panels 13 are made with break or snap lines for breaking off 8″×48″ sections which can be further reduced in length by other snap lines made in the panels. (FIG. 5)

An example of the Foam Board Hydronic Heating kit is comprised of:
a) “Straight Panels”—a board 13 comprising a foam board 2 with parallel grooves 5 to which is bonded a metal plate 1 formed with a tube retaining groove 4 whereby the tube is retained over or in the grooves 5 in the foam.
b) “Transition Panels”—a foam board 10 with portions that contain one or more curved shaped grooves 7 (the Return Portion) to serve as a return for every groove on the Straight panels 13, and in addition has a straight groove 7 that allows for a variety of returns on every second straight plate 13 or more. In a preferred embodiment, the Transitions panels 10 each contain 2 curved end sections and a bypass channel 7 that may be snapped or cut apart to provide extra tube connections, adding flexibility in design. Each transition portion 10 may also include a separate metal plate 9 to be attached after the tubing is installed in the grooved channels 7.
c) Filler panels for where no tube is needed.

A typical kit includes Transition boards 10 with unbonded transition plates 8 together with Straight panels 13 with one or more straight sided grooves in foam board to which a formed aluminum plate or other conductive material is bonded to the top side of the foam but where the plate groove ridges 3 are floating in a board groove 5 large enough to allow outsides of the plate grooves (ridges) to flex enough to allow tubing to be pushed in. The transition return grooves 7 in such a system may have undercut omega channels 7 to retain tubing or simply vertical walls with width that provides a snug fit for tubing.

The foam preferably has a compressive strength greater than 60 PSI. The adhesive that bonds either the straight or the transition plates to the boards may be a water-based adhesive applied to the top of the foam boards. The plates 1 for straight panels 13 may be heated and pressed on the foam 2, changing the “stickiness” and chemical nature of the foam itself, whereby it bonds to the metal plate 1.

The plates 1 for straight panels 13 may be pressed on foam boards 2 where either the under-side of the plate 1 or the top of foam board 2 or both have been sprayed with contact adhesive. The straight panels 13 may be bonded by placing a film double sided adhesive between the plate 1 and the foam board 2, then pressing it with enough pressure to form a strong bond. Heat lamps, heated rollers, or infra-red heaters may be used to increase the tack and bond strength between the plate 1 and the foam board 2.

A kit may include single spacing Transition panels 10 for the tubing, and correctly sized flat metal plates 9 for better heat transfer to bond on top once tubing is installed. An installer may use only the double spaced Transition panels 10 or both single and double spaced Transition panels. The provided plate 9 for the Transition boards 10 may be glued to the foam after the tubing 12 has been installed. The provided plate 9 for the Transitions may be attached to the foam board 10 with retaining clips after the tubing 12 has been installed. The provided plates 9 for the Transitions may be screwed to the foam 10 after the tubing has been installed. A Filler Panel may be included in a kit.

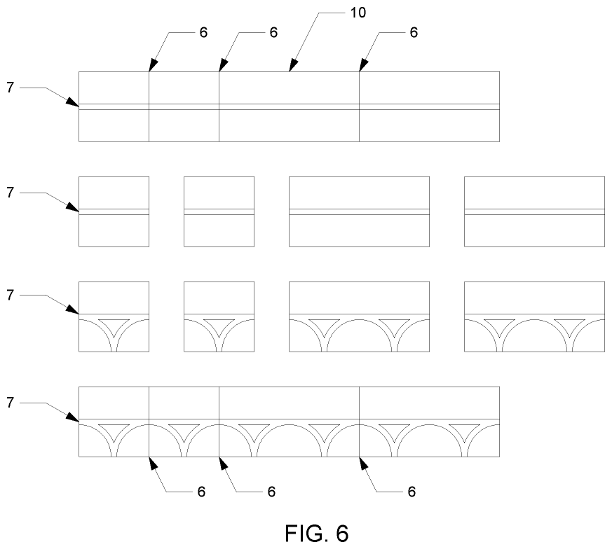

A kit may include Transitions with unbonded plates, together with Straights. The transition return grooves in such a kit may have slightly undercut channels to retain tubing and a design as shown in FIGS. 5 and 6 where 2 rows of return curves and a bypass channel are included, each with a break-line crack between them, allowing for the bypass and curved sections to be snapped apart.

In one embodiment as shown in FIG. 2, the straight boards 13 measure 16″ by 48″ by 1″ or 2″ thick with 2 grooves on 8″ spacing, and the transitions shown in FIG. 5 also measure 16″ by 48″ by 1″ or 2″ thick with routed, molded or heat-formed grooves. The curved grooves in the transitions may have the same spacing as the Straight Emitting Panels, and the grooving allows for bypassing one or more channels in the Straight Emitting Panels.

There may be snap break-line cracks 6 which may be perforations or narrow grooves in the transitions 10 that allow the transitions to be snapped to different convenient widths as shown in FIG. 6. The Transition Panels 10 are made with a variety of snap cracks which allow for the easy breaking of the foam substrata into smaller panels 10 by aligning the crack over the edge of, for example, a table with a square edge, and then pushing one part downward. The snap cracks are of a depth so that the panels do not break with mere handling.

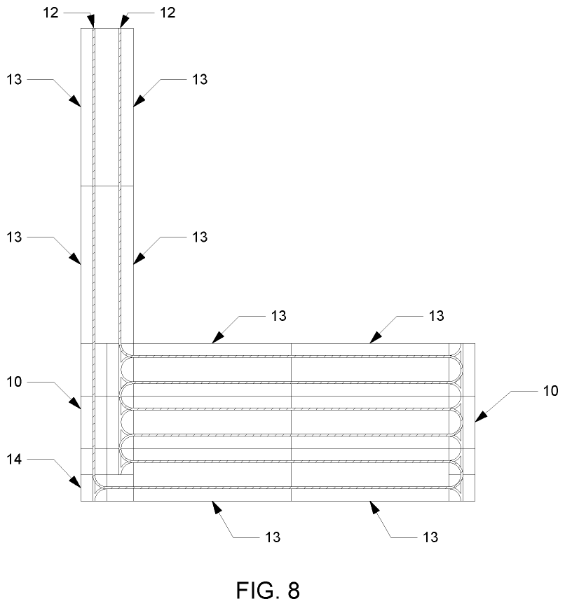

These break-line cracks allow the Transition Panel to be snapped into the curve portion and bypass portions that can be positioned with the Straight Panel as needed, but also to the width of the transition bypass (which is the width of the tube spacing on a Straight Panel) to allow for making a 90° turn from the Transition bypass run beside a Straight Emitting Panel, allowing layouts such as shown in FIG. 8. In the embodiment shown in FIG. 8, the straight portion of a transition panel is used to run up the side of a Straight Panel, and a piece of the return portion of the transition panel is snapped off to make a 90° turn into a return portion of the transition panel.

The snap lines across the boards are multiples of the tube spacing allowing for flexibility in layouts and rotating to change direction in conformance with the modular spacing of the tube channels. Pieces can be swapped in location and the pieces can be rotated all within the modularity established by the groove distance. For example, in the lower left corner of FIG. 8, piece 14 can be an 8″ by 16″ piece rotated differently from the other Transition boards 10 or it can be an 8″ by 8″ square piece beside another 8″ by 8″ square piece.

The modular nature of the groove 7 in the curved transitions 10 allow for variable spacing or variations in the tubing's on center distance. This can be a very desirable feature in keeping costs down in large spaces where the heat loss in the center of a room may be considerably lower than on the perimeter (near exterior walls, windows and doors).

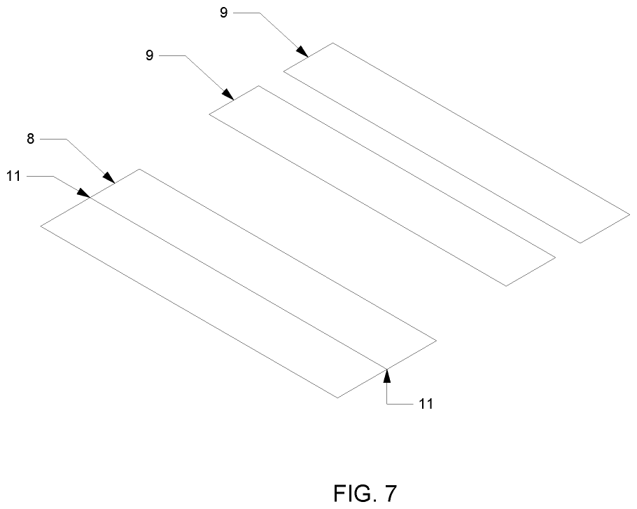

As shown in FIG. 7, the Transition plates 8 for the transition portion may be marked, scribed or perforated with break-line cracks 11 to facilitate cutting or snapping apart to two or more pieces 9 to conform with lengths that the Transition Boards 10 may be snapped to.

The plates 8 to cover the transition boards 10 may have pre-applied adhesive with a peel away covering that can be removed in the field prior to adhering the plates 9 to a portion of a Transition Panel 10. The plates 9 to cover the transition portions 10 may have and be shipped with a two-sided peel away adhesive film with peel away coverings on both sides that can be removed in the field prior to adhering the plates 9 to a portion of a Transition Panel 10.

The Straight Panels 13 that have metal plates adhered to foam can be cut on a table saw with a high tooth carbide metal cutting blade with the metal best placed facing down on the saw table.

The above description does not limit the scope of the invention. The scope of the invention is limited only by the claims.

1. A hydronic board with heat conductive plate kit comprising:
a rectangular board having a length and a width and grooves sized to receive hydronic heat exchange tubing; and
a flat, rectangular heat conductive plate with a length not substantially greater than the length of the board and a width not substantially greater than the width of the board, where an installer may adhere the plate to the board after tubing is inserted into the grooves in the board.

2. The kit of claim 1 where the length of the plate is less than the length of the board, or the width of the plate is less than the width of the board, or both the length of the plate is less than the length of the board and the width of the plate is less than the width of the board.

3. The kit of claim 1 where the board includes:
one or more break-line cracks, each crack having a straight line shape and defining a plane extending through the board perpendicular to a surface of the board;
each crack extending through part of the defined plane but not all of the defined plane such that the board has enough strength to not break at the break-line crack from mere handling, but can be broken at the break-line crack by a person holding the board with two hands and pressing it at a table edge aligned with the break-line crack.

4. The kit of claim 3 where the plate includes:
one or more break-line cracks, each crack having a straight line shape and defining a plane extending through the plate perpendicular to a surface of the plate; each crack extending through part of the defined plane but not all of the defined plane such that the plate has enough strength to not break at the break-line crack from mere handling, but can be broken at the break-line crack by a person holding the plate with two hands and pressing it at a table edge aligned with the break-line crack.

5. The kit of claim 1 where the plate includes break-line cracks at which the plate may be broken and, when the plate is broken at a break-line crack into two or more pieces, the width of one of the pieces is no greater than the width of the board.

6. The kit of claim 1 where the board consists principally of polymer foam.

7. The kit of claim 1 where the grooves comprise 180 degree curved grooves so that the board can be used to make 180 degree turns in tubing.

8. The kit of claim 1 where the grooves in the board have an undercut omega inside shape which allows the groove to retain a snug fitting tube.

9. A hydronic board with heat conductive plate comprising:
a rectangular heat conductive plate having a length and a width, the plate having been bent to have plate ridges on a lower side and plate grooves on an upper side, where the plate grooves are sized to snugly receive hydronic heat exchange tubing; and,
adhered to the lower side of the plate, a rectangular board having a length similar to the length of the plate and a width similar to the width of the plate, the board having board grooves with two sides in which the plate ridges are disposed, the board grooves being more than wide enough between the two sides to receive the plate ridges so that a perpendicular cross-section of a plate ridge is not touching both sides of a board groove at the same time so that the sides of a board groove do not impede initial flexing of a plate ridge.

10. The hydronic board with heat conductive plate of claim 9 where the plates ridges are simply convex with no concavity and the plate grooves are simply concave with no convexity.

11. The hydronic board with heat conductive plate of claim 9 where, in cross-section, the plate ridges and plate grooves have an omega shape such that the ridges and the grooves each have convex portions and concave portions.

12. The hydronic board with heat conductive plate of claim 9 where no perpendicular cross-section of a plate ridge touches both sides of a perpendicular cross-section of a board groove at the same time.

13. The hydronic board with heat conductive plate of claim 9, where each board groove has a bottom and each board groove is deep enough that no plate ridge is touching the bottom of a board groove.

14. The hydronic board with heat conductive plate of claim 9, where the board consists principally of polymer foam.

15. A polymer foam board with heat conductive plate made by a process comprising the steps of:
having a rectangular heat conductive plate with a length and a width, the plate bent to have ridges on a lower side and plate grooves on an upper side where the plate grooves are sized to snugly receive hydronic heat exchange tubing;
having a rectangular board of compatible length and width as the plate, the board consisting principally of polymer foam and having board grooves large enough to receive the ridges of the plate; and,
while the board is at room temperature, heating the plate to a temperature that will melt the polymer of the board, then pressing the plate to the board with the plate ridges inserted into the board grooves, and then allowing the plate and board to cool thereby adhering the plate to the board.

16. The hydronic board with heat conductive plate of claim 13 where the polymer is EPS.

17. A hydronic board with heat conductive plate, comprising:
a board with one or more break-line cracks, each crack having a straight line shape and defining a plane extending through the board perpendicular to a surface of the board;
each crack extending through part of the defined plane but not all of the defined plane such that the board has enough strength to not break at a break-line crack from mere handling but can be broken at the break-line crack by a person holding the board with two hands and pressing it at a table edge aligned with the break-line crack; and,
adhered to the board, a plurality of heat conductive plates, each plate extending close to but not crossing a break-line crack.

18. The hydronic board with heat conductive plate of claim 15 where the board consists principally of polymer foam.
